(19) United States
(12) Patent Application Publication
(10) Pub. No.: US 2015/0287050 A1
(43) Pub. Date: Oct. 8, 2015

(54) SPLIT TESTING FRAMEWORK

(71) Applicant: Olaf Schmidt, Walldorf (DE)

(72) Inventor: Olaf Schmidt, Walldorf (DE)

(21) Appl. No.: 14/246,429

(22) Filed: Apr. 7, 2014

(51) Int. Cl. G06Q 30/02; G06F 11/36; H04L 29/08

(52) U.S. Cl. CPC G06Q 30/0201; H04L 67/10; G06F 11/3676

(57) ABSTRACT

The present disclosure involves systems, software, and computer-implemented methods for providing a split testing framework. An example method includes identifying a test scenario associated with an application, the test scenario including a plurality of variant definitions each including at least one variation in the application, the test scenario including at least one behavior condition to be measured, and a balancing strategy defining how to direct requests to different application variants; initiating a plurality of application variants, each corresponding to one of the plurality of variant definitions in the test scenario and including the variation included in the variant definition; directing requests from a plurality of clients to the plurality of application variants based on the balancing strategy; and determining an effect of each variation in the application on the behavior condition included in the test scenario based on logging data associated with the plurality of application variants.

### BACKGROUND

The present disclosure involves systems, software, and computer-implemented methods for providing a split testing framework.

Split testing is a methodology of using experiments with several variants in controlled experiments. Such experiments are commonly used in web development and marketing, and may involve testing different versions of an application with user traffic to determine the effect of differences between the versions on user behavior.

### SUMMARY

The present disclosure involves systems, software, and computer-implemented methods for providing a split testing framework. In one general aspect, an example method includes identifying a test scenario associated with an application, the test scenario including a plurality of variant definitions each including at least one variation in the application, the test scenario including at least one behavior condition to be measured, and a balancing strategy defining how to direct requests to different application variants; initiating a plurality of application variants, each corresponding to one of the plurality of variant definitions in the test scenario and including the variation included in the variant definition; directing requests from a plurality of clients to the plurality of application variants based on the balancing strategy; and determining an effect of each variation in the application on the behavior condition included in the test scenario based on logging data associated with the plurality of application variants.

While generally described as computer-implemented software embodied on non-transitory, tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example environment for providing a split testing framework according to an implementation.

FIG. 2 is a block diagram illustrating an example testing framework according to an implementation.

FIG. 3 is a block diagram illustrating an interaction between components of an example testing framework according to an implementation.

FIG. 4 is flow chart showing an example method for providing a split testing framework according to an implementation.

### DETAILED DESCRIPTION

This disclosure generally describes computer-implemented methods, computer-program products, and systems for providing a split testing framework. The following description is presented to enable any person skilled in the art to make and use the invention, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Split testing (also referred to as A/B testing or bucket testing) is a methodology of analyzing several variants of an application in controlled experiments. Such experiments are commonly used in web development and marketing. In online settings, such testing may be used to identify changes to web pages and services that increase or maximize an outcome of interest (e.g., sign-up rate, click-through rate for banner ads, and/or other outcomes of interest).

Implementations according to the present disclosure may provide a generic split testing framework allowing developers to define and execute split testing scenarios on large scale applications. Some implementations may identify a test scenario associated with an application. The identified test scenario may include multiple variant definitions, each including at least one variation in the application. The test scenario may also include at least one behavior condition to be measured, and a balancing strategy defining how to direct requests to different application variants. Multiple application variants, each corresponding to one of the variant definitions, may be initiated. Each variant includes a variation included in the variant definition. Requests are then directed from clients to the different application variants based on the balancing strategy included in the test scenario. An effect is then determined of each variation in the application on the behavior condition included in the test scenario based on logging data associated with the plurality of application variants.

Implementations according to the present disclosure may provide several advantages over prior techniques. By providing a generic framework for testing large scale applications (e.g., cloud applications), split testing may be performed more easily than previous techniques, which generally required the tests to developed and implemented individually. Further, by providing a direct comparison between different application variants executing simultaneously, the effects of various changes can be identified more quickly and accurately than with prior techniques.

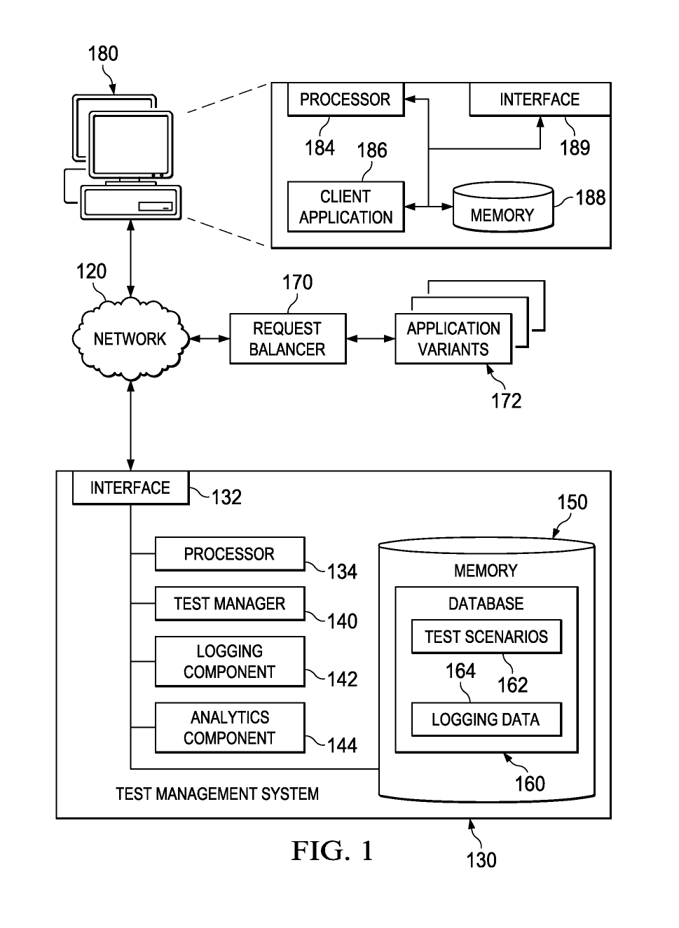

FIG. 1 is a block diagram illustrating an example environment for providing a split testing framework according to an implementation. As shown, the environment 100 includes a network 120 connected to a test management system 130, one or more clients 180, a request balancer 170, and a plurality of application variants 172. In operation, the test management system 130 may create the one or more application variants 172 according to defined test scenarios. The request balancer 170 may direct user requests to the different application variants 172 according to a balancing strategy included in the test scenario. Logging data produced by the application variants 172 may be analyzed to determine what effect, if any, the changes between the different application variants 172 have on user behavior. For example, two application variants 172 may include different versions of a payment sequence. The logging data may be analyzed to determine what effect the different versions of the payment sequence have on the percentage of customers that complete the payment. By analyzing the logging data, the more effective version of the payment sequence may be identified and put in production.

The environment 100 includes a test management system 130. In some implementations, the test management system 130 may be operable to maintain and manage the defined test scenarios, collect logging data associated with the different application variants 172, and perform analysis on the logging data. In some implementations, the test management system 130 may be a computer or set of computers operable to perform these operations. In some cases, the various operations may be performed by different servers communicating with one another, such as over the network 120.

As used in the present disclosure, the term “computer” is intended to encompass any suitable processing device. For example, although FIG. 1 illustrates a test management system 130, environment 100 can be implemented using two or more servers, as well as computers other than servers, including a server pool. Indeed, test management system 130 may be any computer or processing device such as, for example, a blade server, general-purpose personal computer (PC), MAC, workstation, UNIX-based workstation, or any other suitable device. In other words, the present disclosure contemplates computers other than general purpose computers, as well as computers without conventional operating systems. Further, illustrated test management system 130 may be adapted to execute any operating system, including LINUX, UNIX, WINDOWS, MAC OS, JAVA, ANDROID, iOS or any other suitable operating system. According to one implementation, test management system 130 may also include or be communicably coupled with an e-mail server, a Web server, a caching server, a streaming data server, and/or other suitable server.

The test management system 130 also includes an interface 132, a processor 134, and a memory 150. The interface 132 is used by the test management system 130 for communicating with other systems in a distributed environment—including within the environment 100—connected to the network 120; for example, the clients 180, as well as other systems communicably coupled to the network 120 (not illustrated). Generally, the interface 132 comprises logic encoded in software and/or hardware in a suitable combination and operable to communicate with the network 120. More specifically, the interface 132 may comprise software supporting one or more communication protocols associated with communications such that the network 120 or interface's hardware is operable to communicate physical signals within and outside of the illustrated environment 100.

As illustrated in FIG. 1, the test management system 130 includes a processor 134. Although illustrated as a single processor 134 in FIG. 1, two or more processors may be used according to particular needs, desires, or particular implementations of environment 100. Each processor 134 may be a central processing unit (CPU), a blade, an application specific integrated circuit (ASIC), a field-programmable gate array (FPGA), or another suitable component. Generally, the processor 134 executes instructions and manipulates data to perform the operations of the test management system 130.

As shown, the test management system 130 includes a test manager 140. In operation, the test manager 140 may read test scenarios 162 from the database 160, and may create and execute the application variants 172 according to the test scenarios 162. In some implementations, the test manager 140 may also instantiate a request balancer 170 to handle requests for the application variants 172. In some cases, the test manager 140 may inform an existing request balancer 170 of a balancing strategy defined in the particular test scenario 162 to be implemented.

In some implementations, the test manager 140 may build and/or compile the different application variants 172 defined by the particular test scenario 162. For example, the test scenario 162 may include a definition of the differences between the different application variants 172. The test manager 140 may build different versions of the application including these differences, and may execute these versions as the application variants 172. In some implementations, prebuilt versions of the application may be stored in the database 160 associated with the particular text scenario 162. In such a case, the test manager 140 may execute these prebuilt application versions as the application variants 172. The precompiled application versions may also be stored in an external storage system (not shown).

As shown, the test management system 130 includes a logging component 142. In some implementations, logging component 142 may receive logging data from the application variants 172 and store it in the database 160 as logging data 164. In some cases, the logging component 142 may receive log messages from the one or more application variants 172 over the network 120. Log messages may be formatted according to a network management protocol, such as, for example, Simple Network Management Protocol (SNMP). The logging component 142 may also retrieve logging data from the one or more application variants 172, such as by reading from log files associated with the application variants 172. In some implementations, the logging component 142 may also receive logging data from the request balancer 170, or from other network components.

The test management system 130 also includes an analytics component 144. In operation, the analytics component 144 analyzes the logging data 164 to determine the effect of the different application variants 172. In some implementations, the analysis performed by the analyst component 144 is defined within the test scenarios 162. For example, a test scenario 162 may define to application variants, and define a measurement is expected to vary between the two application variants. The analyst component 144 may evaluate this measurement, and produce a report showing the effect of the different application variants on the measurement. For example, the test scenario 162 may define two different application flows for a customer survey. The test scenario 162 may define that the abandonment rate for the survey is expected to vary between the two variants. The analytics component 144 may analyze the logging data 164 associated with the two application variants, and determine which of the two application variants has a lower abandonment rate.

In some implementations, the test manager 140, the logging component 142, and the analytics component 144 may be software applications executing on the test management system 130. The test manager 140, the logging component 142, and the analytics component 144 may be separate software applications, or may be separate software modules inside the same software application.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The test management system 130 also includes a memory 150 or multiple memories 150. The memory 150 may include any type of memory or database module and may take the form of volatile and/or non-volatile memory including, without limitation, magnetic media, optical media, random access memory (RAM), read-only memory (ROM), removable media, or any other suitable local or remote memory component. The memory 150 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the test management system 130. Additionally, the memory 150 may include any other appropriate data, such as VPN applications, firmware logs and policies, firewall policies, a security or access log, print or other reporting files, as well as others.

As illustrated in FIG. 1, memory 150 includes or references data and information associated with and/or related to providing the network service load control. As illustrated, memory 150 includes a database 160. The database 160 may be one of or a combination of several commercially available database and non-database products. Acceptable products include, but are not limited to, SAP® HANA DB, SAP® MaxDB, Sybase® ASE, Oracle® databases, IBM® Informix® databases, DB2, MySQL, Microsoft SQL Server®, Ingres®, PostgreSQL, Teradata, Amazon SimpleDB, and Microsoft® Excel, as well as other suitable database and non-database products. Further, database 160 may be operable to process queries specified in any structured or other query language such as, for example, Structured Query Language (SQL).

As shown, the database 160 includes test scenarios 162. The test scenarios 162 defined how a particular application should be varied, and what effects should be measured when running the associated application variants 172. In some implementations, the test scenarios 162 may include precompiled versions of the different application variants 172 to be tested. The test scenarios 162 may also include code to be compiled in order to produce the application variants 172. The test scenarios 162 may also include a balancing strategy to apply to requests sent to the application variants 172.

The database 160 also includes logging data 164. In some implementations, the logging data 164 is stored as rows within a table within the database 160. Logging data 164 may also be stored in a log file or collection of log files, such that data is appended to the file as it is received. In some implementations, the logging data 164 is stored in a raw format, such that log data received from the application variants 172 in the request balancer 170 are stored in the format in which the received. The logging data 164 may also be stored in a compressed format. In some implementations, only a subset of the logging data received from the application variants 172 in the request balancer 170 may be stored in the database 160. For example, logging data received from the application variants 172 in the request balancer 170 may be stored in the database 160 if it is applicable to a particular one of the test scenarios 162.

The environment 100 also includes a request balancer 170. In operation, the request balancer 170 directs requests to the application variants 172 based on a balancing strategy included in the particular test scenario 162. For example, the test scenario 162 may define that request should be sent to the application variants 172 in a round-robin fashion, randomly, or by some other balancing strategy. In some implementations, the request balancer 170 may be a computer or set of computers connected to the network 120 to perform the described functions.

The environment 100 also includes a plurality of application variants 172. In some implementations, the application variants 172 may be software applications corresponding to the different variations of a base application defined in a particular one of the test scenarios 162. The application variants 172 may execute on a computer or set of computers connected to the network 120. In some implementations, the computers executing the application variants 172 may be separate from the computer executing the request balancer 170. The components may also be located on the same computer. In some implementations, the application variants 172 may send logging data over the network 122 the test management system 130. The application variants 172 may also utilize the logging data API provided by the test management system 130, such that the application variants 172 may call functions to provide the test management system 130 with logging data. The application variants 172 may also write logging data to log files on the computer on which their executing, or on an external computer.

Illustrated client 180 is intended to encompass any computing device, such as a desktop computer, laptop/notebook computer, wireless data port, smart phone, personal data assistant (PDA), tablet computing device, one or more processors within these devices, or any other suitable processing device. For example, client 180 may comprise a computer that includes an input device, such as a keypad, touch screen, or other device that can accept user information and an output device that conveys information associated with the operation of the test management system 130 or client 180 itself, including digital data, visual information, or a graphical user interface (GUI). Client 180 may include an interface 189, a processor 184, a memory 188 and a client application 186. In some implementations, the client application 186 may be a web browser. Client 180 may be used by a user to access the test management system 130 to view or change items in the database 160, such as test scenarios 162. In some implementations, the client application 186 may be application configured to allow a user to define the test scenarios 162.

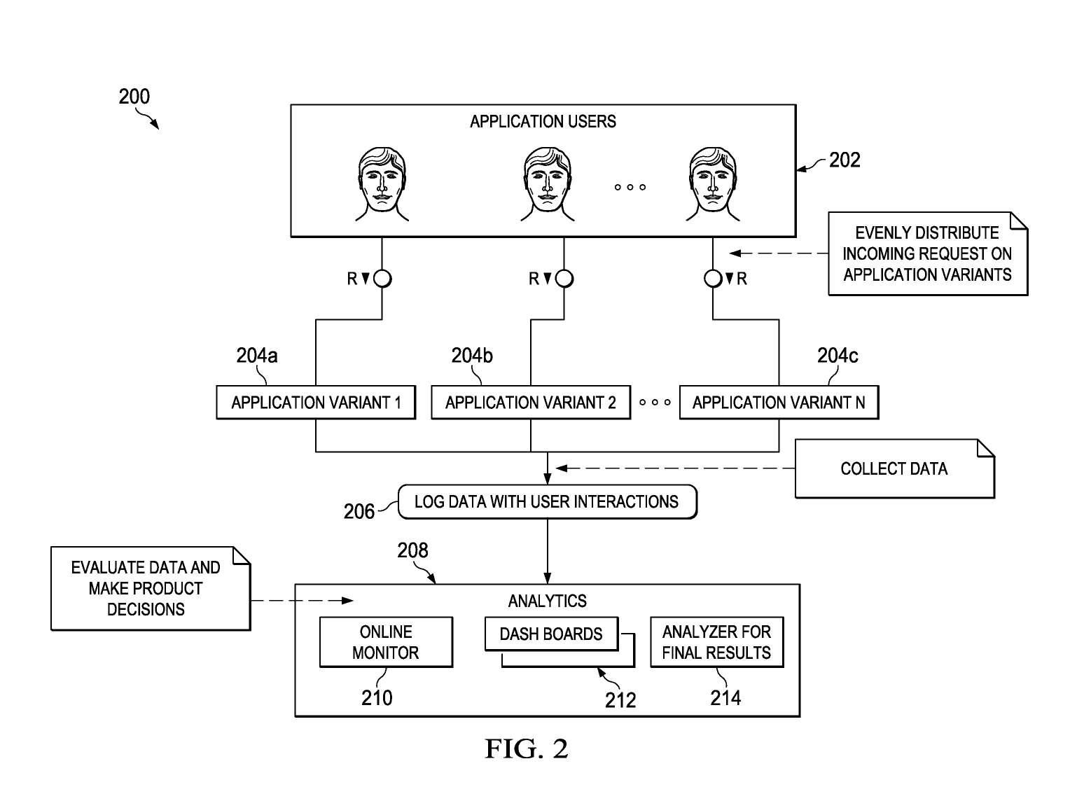

FIG. 2 is a block diagram illustrating an example testing framework according to an implementation. As shown, the application users 202 access the application variants 204a-c. The application variants 204a-c receives produced log data 206 based on the interactions with the user's 202. The log data 206 is read by an analytics component 208. The analytics component 208 includes an online monitor 210. The online monitor 210 may show the status of the application variants 204a-c as a test is running. For example, the online monitor 210 may display a real time representation of the performance of the application variants 204a-c based on the log data 206 as it is received.

The analysis component 208 also includes one or more dashboards 212. The dashboards 212 may each display results of a split test in real time as the log data 206 is received. For example, if the particular test scenario is concerned with user abandonment rate, one of the dashboards 212 may display the user abandonment rate for the different application variants 204a-c in real time. In some implementations, each measurement defined by the test scenario will have a separate dashboard 212. The measurements may also be displayed on a single dashboard to 212.

The analysis component 208 also includes an analyzer 214. The analyzer 214 may be operable to produce final results associated with a test scenario. For example, the analyzer 214 may analyze the log data 206 after a particular test scenario is finished running, and produce a report showing the observed measurements for the different application variants.

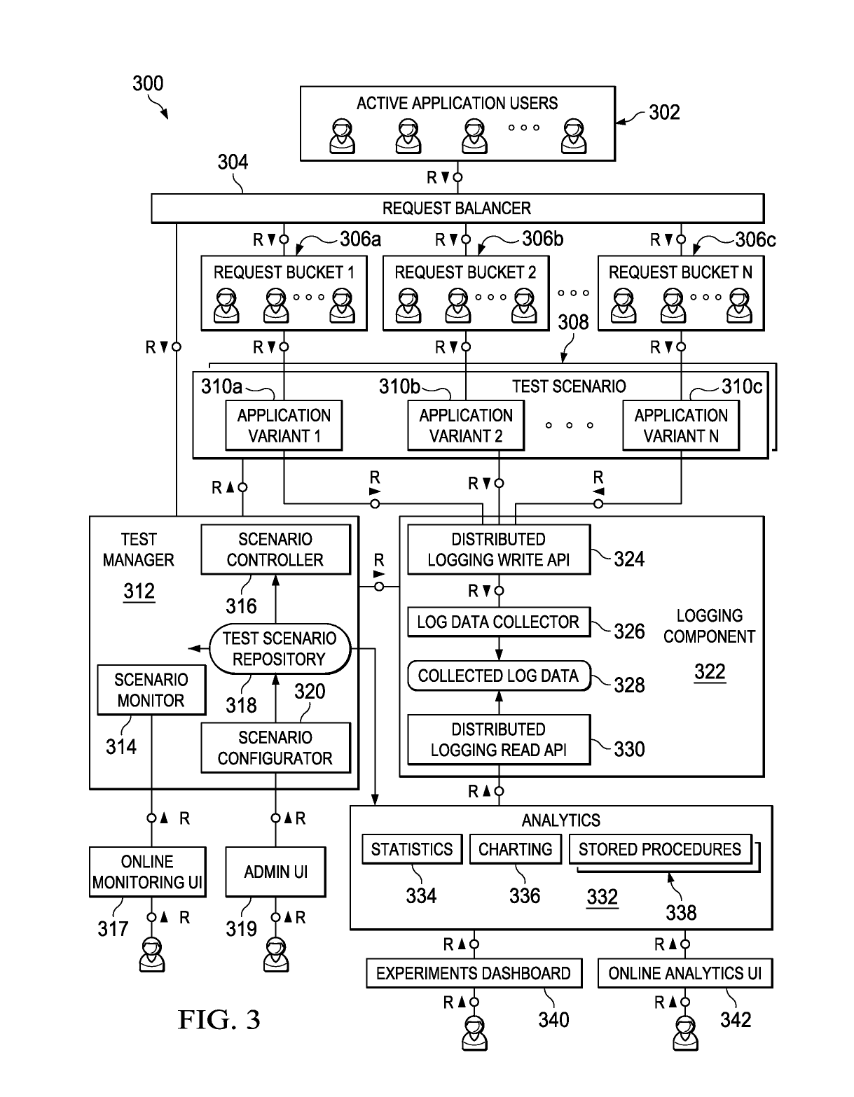

FIG. 3 is a block diagram illustrating an interaction between components of an example testing framework according to an implementation. As shown, application users 302 send requests to a request balancer 304. The request balancer 304 places the receive requests into one of the request buckets 306a-c. In some implementations, each request bucket 306a-c corresponds to one of the application variants 310a-c. In some cases, the request buckets 306a-c are queues, such that inserted requests we processed in order.

Application variants 310a-c are included in a test scenario 308. The application variants 310a-c receive requests from the request buckets 306a-c, and process the requests according to their defined behaviors. In some implementations, the application variants 310a-c may send responses to the application users 302 in response to the receive requests. In some cases, the application variants 310a-c may communicate directly with the application users 302, or the application variants 310a-c may communicate through the request balancer 304.

The test manager 312 interacts with the request balancer 304 and the application variants 310a-c. In some implementations, the test manager 312 may communicate a balancing strategy for particular test scenario 308 to the request balancer 304. The test manager 312 may also create and manage the different application variants 310a-c.

As shown, the test manager 312 includes a scenario monitor 314. The scenario monitor 314 may produce a report showing the real-time status of the test scenario 308. In some implementations, scenario monitor 314 may produce a report showing statistics for the different application variants 310a-c. In some cases, the scenario monitor 314 may provide this report to an online monitoring UI 317 for viewing by a user.

The test manager 312 includes a scenario controller 316. In some implementations, the scenario controller 316 may be operable to build, compile, and/or execute the application variants 310a-c defined in a particular test scenario. The test manager 312 also includes a test scenario repository 318. In some implementations, the test scenario repository 318 may include definitions for different test scenarios, such as the test scenarios 162 defined in FIG. 1.

Test manager 312 also includes a scenario configurator 320. In some implementations, the scenario configurator 320 may allow a user to define new test scenarios, update existing test scenarios, or delete test scenarios from the test scenario repository 318. In some implementations, the user may access the scenario configurator 320 through the admin UI 319.

The environment 300 also includes a logging component 322. In operation, the log 322 may receive logging data from the request balancer 304 and the application variants 310a-c. As shown, the logging component 322 provides a distributed logging write API 324 may be utilized by the request balancer 304 and the application variants 310a-c to write logging data to the logging component 322 for use by the rest of the system. The logging component 322 includes a data collector 326 that processes the logging data received via the distributed logging right API 324. The log data collector 326 stores this log data as collected log data 328. Log component 322 also includes a distributed logging read API 330 that allows other components to read the collected log data 328.

The environment 300 also includes analytics component 332. In some implementations, the analytics component 332 performs operations similar to the analytics component 144 describe relative to FIG. 1. As shown, the analytics component 332 includes statistics routines 334, charting routines 336, and stored procedures 338. These components may be operable to produce reports consumable by the experiments dashboard 340, and the online analytics UI 342 for viewing by users.

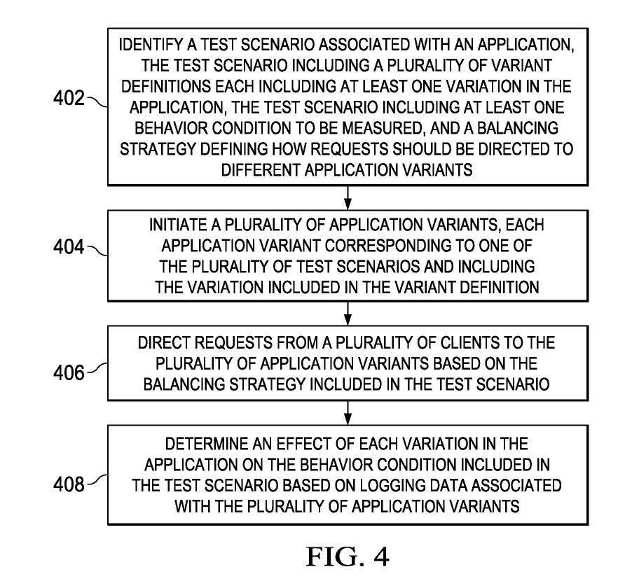

FIG. 4 is flow chart showing an example method for providing a split testing framework according to an implementation. For clarity of presentation, the description that follows generally describes method 400 in the context of FIGS. 1-3. However, method 400 may be performed, for example, by any other suitable system, environment, software, and hardware, or a combination of systems, environments, software, and hardware, as appropriate. For example, one or more of the test management system, the client, or other computing device (not illustrated) can be used to execute method 400 and obtain any data from the memory of the client, navigation management system, or the other computing device (not illustrated).

At 402, a test scenario associated with an application is identified. The test scenario may include a plurality of varying definitions each including at least one variation of the application. The test scenario may also include at least one behavior condition to be measured, and a balancing strategy defining how requests should be directed to different application variants.

In some implementations, identifying the test scenario includes identifying user characteristics included in the balancing strategy, and directing requests from the plurality of clients to the plurality of application variants includes directing requests based on user characteristics of the requesting users according to the balancing strategy. The user characteristics may include at least one of: age, gender, location, user role, or pay status. In some cases, the behavior condition may include one or more of user response time, user abandonment percentage, user acceptance percentage, click-through percentage, or other behavior conditions.

At 404, a plurality of application variants are initiated, each application varying corresponding to one of the plurality of test scenarios including the variation included in the variant definition. At 406, requests are directed from plurality of clients to the plurality of application variants based on the balancing strategy included the test scenario. In some implementations, the application is a web application and directing the requests includes directing Hypertext Transfer Protocol (HTTP) requests received from the plurality of clients. At 408, and effective each variation in the application on the behavior condition included in the test scenario is determined based on logging data associated with the plurality of application variants.

In some cases, the method 400 may include presenting a report including one or more performance metrics associated with each application variant while requests are being directed to the plurality of application variants. The performance metrics include one or more of CPU utilization, memory utilization, network utilization, load average, request throughput, or other performance metrics.

The preceding figures and accompanying description illustrate example processes and computer implementable techniques. Environment 100 (or its software or other components) contemplates using, implementing, or executing any suitable technique for performing these and other tasks. These processes are for illustration purposes only and that the described or similar techniques may be performed at any appropriate time, including concurrently, individually, or in combination. In addition, many of the steps in these processes may take place simultaneously, concurrently, and/or in different order than as shown. Moreover, environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method executed by one or more processors, the method comprising:
identifying a test scenario associated with an application, the test scenario including a plurality of variant definitions each including at least one variation in the application, the test scenario including at least one behavior condition to be measured, and a balancing strategy defining how to direct requests to different application variants;
initiating a plurality of application variants, each application variant corresponding to one of the plurality of variant definitions in the test scenario and including the variation included in the variant definition;
directing requests from a plurality of clients to the plurality of application variants based on the balancing strategy included in the test scenario; and
determining an effect of each variation in the application on the behavior condition included in the test scenario based on logging data associated with the plurality of application variants.

2. The method of claim 1, wherein identifying the test scenario includes identifying user characteristics included in the balancing strategy, and directing requests from the plurality of clients to the plurality of application variants includes directing requests based on user characteristics of the requesting users according to the balancing strategy.

3. The method of claim 2, wherein the user characteristics include at least one of: age, gender, location, user role, or pay status.

4. The method of claim 1, wherein the behavior condition includes at least one of: user response time, user abandonment percentage, user acceptance percentage, or click-through percentage.

5. The method of claim 1, further comprising presenting a report including one or more performance metrics associated with each application variant while requests are being directed to the plurality of application variants.

6. The method of claim 5, wherein the performance metrics include at least one of: CPU utilization, memory utilization, network utilization, load average, or request throughput.

7. The method of claim 1, wherein the application is a web application and directing the requests includes directing Hypertext Transfer Protocol (HTTP) requests received from the plurality of clients.

8. A non-transitory, computer-readable medium storing instructions operable when executed to cause at least one processor to perform operations comprising:
identifying a test scenario associated with an application, the test scenario including a plurality of variant definitions each including at least one variation in the application, the test scenario including at least one behavior condition to be measured, and a balancing strategy defining how to direct requests to different application variants;
initiating a plurality of application variants, each application variant corresponding to one of the plurality of variant definitions in the test scenario and including the variation included in the variant definition;
directing requests from a plurality of clients to the plurality of application variants based on the balancing strategy included in the test scenario; and
determining an effect of each variation in the application on the behavior condition included in the test scenario based on logging data associated with the plurality of application variants.

9. The computer-readable medium of claim 8, wherein identifying the test scenario includes identifying user characteristics included in the balancing strategy, and directing requests from the plurality of clients to the plurality of application variants includes directing requests based on user characteristics of the requesting users according to the balancing strategy.

10. The computer-readable medium of claim 9, wherein the user characteristics include at least one of: age, gender, location, user role, or pay status.

11. The computer-readable medium of claim 8, wherein the behavior condition includes at least one of: user response time, user abandonment percentage, user acceptance percentage, or click-through percentage.

12. The computer-readable medium of claim 8, the operations further comprising presenting a report including one or more performance metrics associated with each application variant while requests are being directed to the plurality of application variants.

13. The computer-readable medium of claim 12, wherein the performance metrics include at least one of: CPU utilization, memory utilization, network utilization, load average, or request throughput.

14. The computer-readable medium of claim 8, wherein the application is a web application and directing the requests includes directing Hypertext Transfer Protocol (HTTP) requests received from the plurality of clients.

15. A system comprising:
memory for storing data; and
one or more processors operable to perform operations comprising:
identifying a test scenario associated with an application, the test scenario including a plurality of variant definitions each including at least one variation in the application, the test scenario including at least one behavior condition to be measured, and a balancing strategy defining how to direct requests to different application variants;
initiating a plurality of application variants, each application variant corresponding to one of the plurality of variant definitions in the test scenario and including the variation included in the variant definition;
directing requests from a plurality of clients to the plurality of application variants based on the balancing strategy included in the test scenario; and
determining an effect of each variation in the application on the behavior condition included in the test scenario based on logging data associated with the plurality of application variants.

16. The system of claim 15, wherein identifying the test scenario includes identifying user characteristics included in the balancing strategy, and directing requests from the plurality of clients to the plurality of application variants includes directing requests based on user characteristics of the requesting users according to the balancing strategy.

17. The system of claim 16, wherein the user characteristics include at least one of: age, gender, location, user role, or pay status.

18. The system of claim 15, wherein the behavior condition includes at least one of: user response time, user abandonment percentage, user acceptance percentage, or click-through percentage.

19. The system of claim 15, the operations further comprising presenting a report including one or more performance metrics associated with each application variant while requests are being directed to the plurality of application variants.

20. The system of claim 19, wherein the performance metrics include at least one of: CPU utilization, memory utilization, network utilization, load average, or request throughput.
